(19) United States
(12) Patent Application Publication
(10) Pub. No.: US 2015/0262505 A1
(43) Pub. Date: Sep. 17, 2015

(54) Devices and Methods for Teaching Healthy Eating and Exercise Habits

(71) Applicant: Cara Zaller, Columbia, MD (US)

(72) Inventor: Cara Zaller, Columbia, MD (US)

(21) Appl. No.: 14/175,005

(22) Filed: Feb. 7, 2014

Related U.S. Application Data
(60) Provisional application No. 61/761,920, filed on Feb. 7, 2013.

(51) Int. Cl. G09B 19/00

(52) U.S. Cl. CPC G09B 19/0092

(57) ABSTRACT

A game for teaching healthy eating and exercise habits comprising a playing surface comprising a playing path that includes multiple healthy food positions, multiple energy-draining food positions and multiple activity positions; multiple game pieces that are operable for advancing along the playing path and a randomizer configured to determine how many positions a player can advance one of the game pieces along the playing path. A player whose game piece lands on an activity position may be required to perform one or more exercises.

### RELATED APPLICATION

This application claims priority under 35 U.S.C. §119(e) to U.S. Provisional Patent Application No. 61/761,920, filed Feb. 7, 2013, the disclosure of which is incorporated herein by reference in its entirety.

### FIELD OF THE INVENTION

The present invention relates to games that teach healthy eating and exercise habits.

### BACKGROUND

Given the rapid rise in the prevalence of childhood obesity, there exists a need for educational tools whereby children may be taught healthy eating and exercise habits. The present invention addresses that need by providing devices and methods for teaching healthy eating and exercise habits.

### SUMMARY OF THE INVENTION

In some embodiments, the present invention provides a game for teaching healthy eating and exercise habits, wherein the game comprises a playing surface comprising a playing path that includes a plurality of healthy food positions, a plurality of energy-draining food positions and a plurality of activity positions; a plurality of game pieces that are operable to advance along the playing path; and a randomizer configured to determine how many positions a player can advance his/her game piece along the playing path. In some such embodiments, the game further comprises an activity selector, a plurality of puzzle pieces, an answer key and reward selector and/or a penalty selector.

In some embodiments, the presenting invention provides a method for teaching healthy eating and exercise habits, wherein the method comprises advancing a game piece along a playing path comprising a plurality of contiguous positions, wherein the plurality of contiguous positions comprises a plurality of healthy food positions, a plurality of energy-draining food positions and a plurality of activity positions. In some such embodiments, a player whose game piece is advanced to a healthy food position is directed to identify which type(s) of healthy food is represented by the healthy food position: fruits, vegetables, animal proteins and/or nuts/seeds. Similarly, in some such embodiments, a player whose game piece is advanced to an activity position is required to perform one or more exercises.

It is noted that aspects of the inventive concepts described with respect to one embodiment may be incorporated in a different embodiment although not specifically described relative thereto. That is, all embodiments and/or features of any embodiments can be combined in any way and/or combination. These and other objects and/or aspects of the present invention are explained in detail in the specification set forth below

### BRIEF DESCRIPTION OF THE DRAWINGS

FIGS. 1A-1B depict playing surfaces according to some embodiments of the present invention.

FIGS. 2A-2B depict activity cards according to some embodiments of the present invention.

FIGS. 3A-3B depict puzzle piece sets according to some embodiments of the present invention.

FIGS. 4A-4B depict answer keys according to some embodiments of the present invention.

FIGS. 5A-5B are exemplary sets of instructions according to some embodiments of the present invention.

FIG. 6 is a flow chart of a method according to some embodiments of the present invention.

FIG. 7 is a flow chart of a method according to some embodiments of the present invention.

### DETAILED DESCRIPTION

The present invention is described more fully hereinafter with reference to the accompanying drawings, in which embodiments of the present invention are shown. This invention may, however, be embodied in many different forms and should not be construed as limited to the embodiments set forth herein. Rather, these embodiments are provided so that this disclosure will be thorough and complete, and will fully convey the scope of the present invention to those skilled in the art. In the drawings, the sizes and relative sizes of components and regions may be exaggerated for clarity. Like numbers refer to like elements throughout.

It will be understood that when an element or layer is referred to as being “on”, “connected to” or “coupled to” another element or layer, it can be directly on, connected or coupled to the other element, or layer or intervening elements or layers may be present. In contrast, when an element is referred to as being “directly on,” “directly connected to” or “directly coupled to” another element or layer, there are no intervening elements or layers present.

The terminology used herein is for the purpose of describing particular embodiments only, and is not intended to be limiting of the present invention.

Unless otherwise defined, all terms (including technical and scientific terms) used herein have the same meaning as commonly understood by one of ordinary skill in the art to which this invention belongs. Accordingly, these terms can include equivalent terms that are created after such time. It will be further understood that terms, such as those defined in commonly used dictionaries, should be interpreted as having a meaning that is consistent with their meaning in the present specification and in the context of the relevant art, and will not be interpreted in an idealized or overly formal sense unless expressly so defined herein.

As used herein, the singular forms “a”, “an” and “the” are intended to include the plural forms as well, unless the context clearly indicates otherwise.

As used herein, the term “about,” when used in reference to a measurable value such as an amount of time, a number of repetitions and the like, is meant to encompass both the specified amount and variations of 20%, 15%, 10%, 7.5%, 5%, 2.5% 1%, 0.5%, or even 0.1% of the specified amount.

As used herein, the term “and/or” refers to and encompasses any and all possible combinations of one or more of the associated listed items, as well as the lack of combinations when interpreted in the alternative (“or”).

As used herein, the terms “comprise,” “comprises,” “comprising,” “include,” “includes,” and “including” (and grammatical variants thereof) specify the presence of stated features, integers, steps, operations, elements, and/or components, but do not preclude the presence or addition of one or more other features, integers, steps, operations, elements, components, and/or groups thereof.

As used herein, the term “exercise” (and grammatical variants thereof) refers to any form of bodily exertion that is carried out for the sake of developing and/or maintaining physical and/or mental fitness. Exemplary forms of exercise include, but are not limited to, aerobics, archery, badminton, baseball, basketball, calisthenics (e.g., bear crawls, burpees, calf-raises, crunches, dips, flutter kicks, front kicks, jumping jacks, lunges, mountain climbers, pull-ups, push-ups, sit-ups, squats and star jumps), canoeing, cheerleading, climbing, cross country skiing, cycling, dancing, football, golf, gymnastics, hiking, hockey, ice skating, jogging, jumping rope, martial arts, rock climbing, rollerblading, rowing, running, soccer, skateboarding, skiing, swimming, tennis, tug-of-war, volleyball, walking, weight lifting, wrestling and yoga (e.g., big toe pose, bow pose, bridge pose, camel pose, cat pose, chair pose, cobra pose, cow pose, crane pose, dolphin pose, dolphin plank pose, downward-facing dog pose, eagle pose, extended triangle pose, feathered peacock pose, fish pose, frog pose, full boat pose, half moon pose, happy baby pose, locust pose, mountain pose, plank pose, plow pose, tree pose, upward salute, upward-facing dog pose, warrior pose, warrior II pose, warrior III pose). In some embodiments of the present invention, exercise refers to a physical activity selected from the group consisting of calisthenics and yoga.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

All publications, patent applications, patents, and other references mentioned herein are incorporated by reference in their entirety.

As noted above, the present invention provides devices for teaching healthy eating and exercise habits. In some embodiments, the present invention provides a game for teaching healthy eating and exercise habits.

Games of the present invention may include one or more playing paths on a playing surface; one or more game pieces and a randomizer. Games of the present invention may further include an activity selector, multiple puzzle pieces, an answer key, a reward selector, a penalty selector and/or a set of instructions.

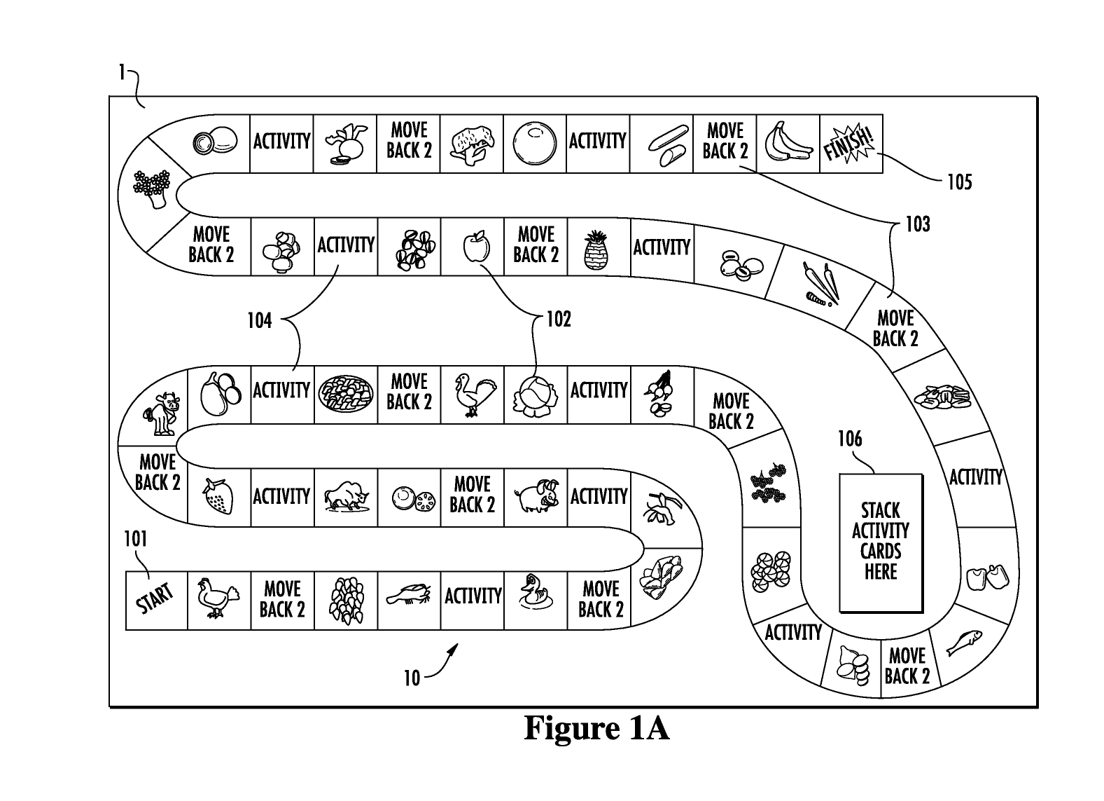

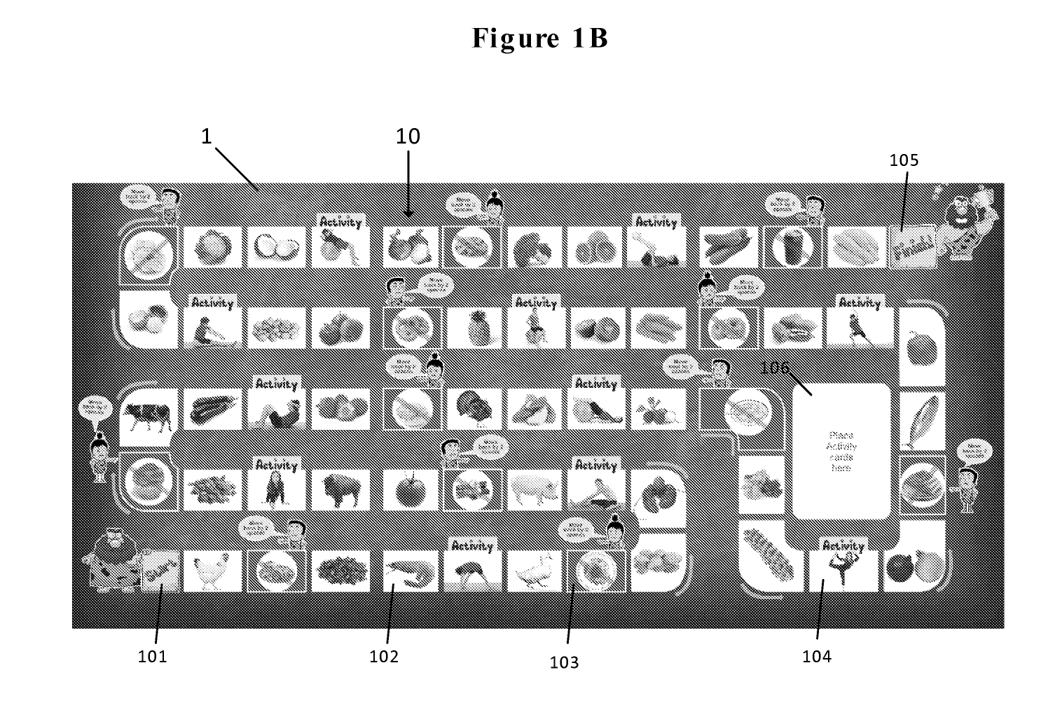

As shown in FIGS. 1A-1B, in some embodiments of the present invention, the game may include a playing surface 1 comprising a playing path 10 that includes a start position 101, multiple healthy food positions 102 comprising a graphical representation of a healthy food item, multiple energy-draining food positions 103 comprising a graphical representation of an energy-draining food item, multiple activity positions 104 and a goal position 105. In some embodiments, the playing surface further includes an activity card stacking area 106 for stacking one or more activity cards 107.

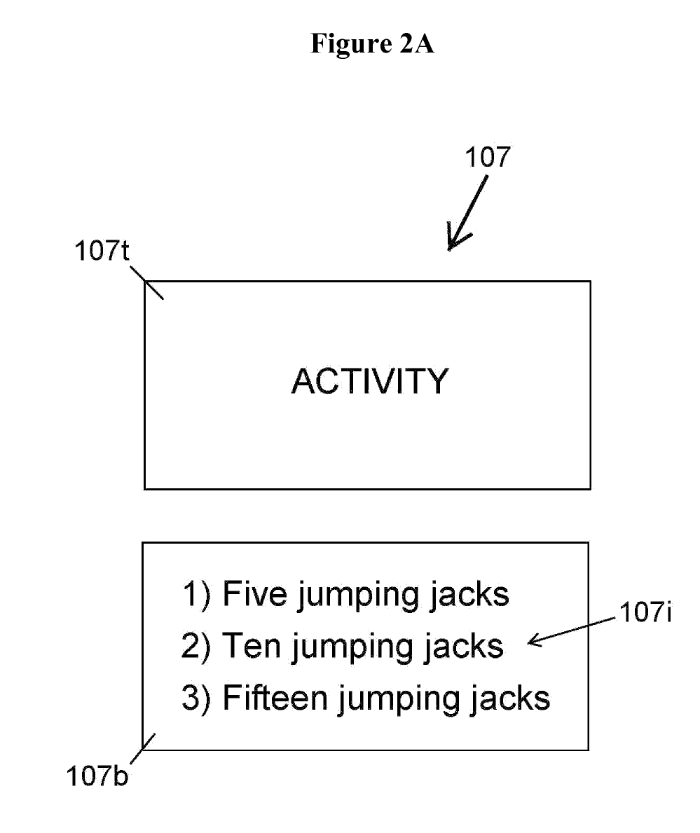

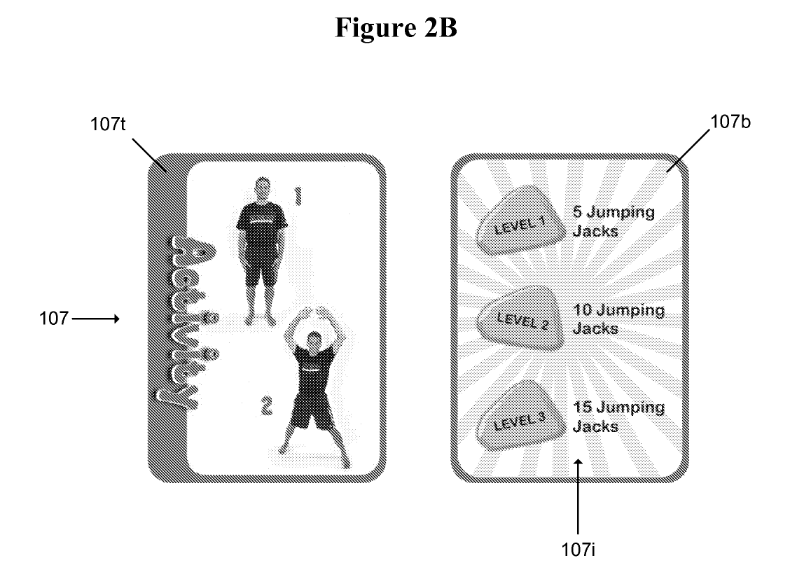

As shown in FIGS. 2A-2B, each activity card 107 may include a top side 107t and a bottom side 107b, the bottom side 107b comprising instructions for performing an exercise 107i. Also as shown in FIGS. 2A-2B, the instructions for performing an exercise 107i may include instructions for performing the exercise in accordance with alternative methods and/or sets of performance parameters.

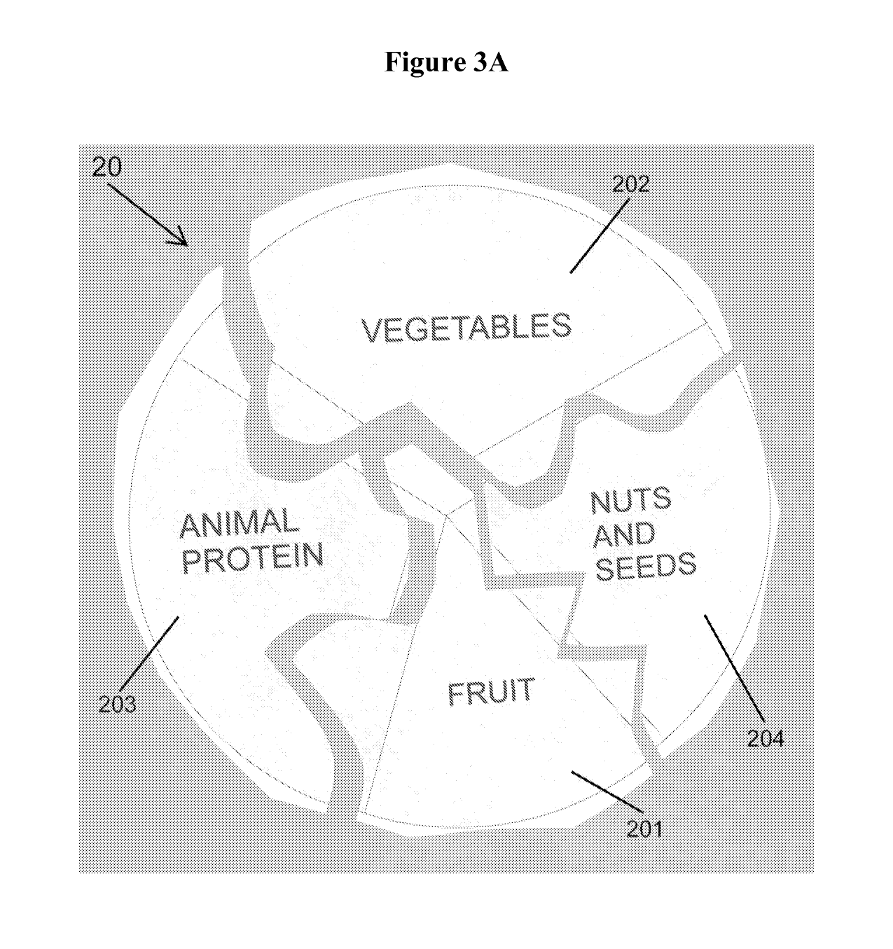

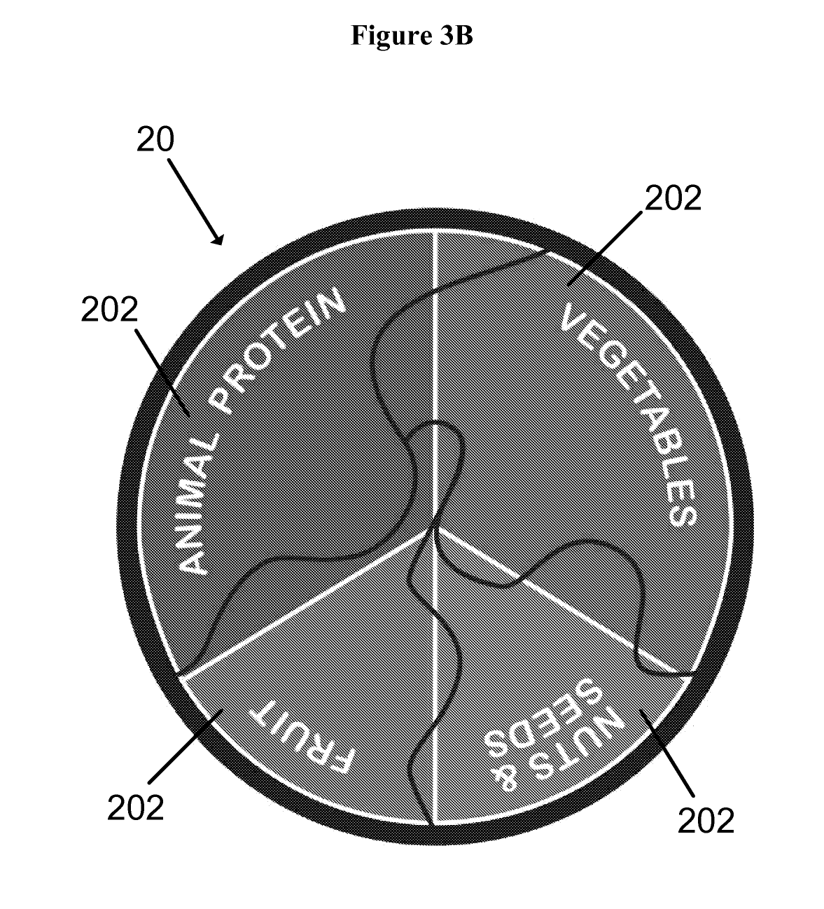

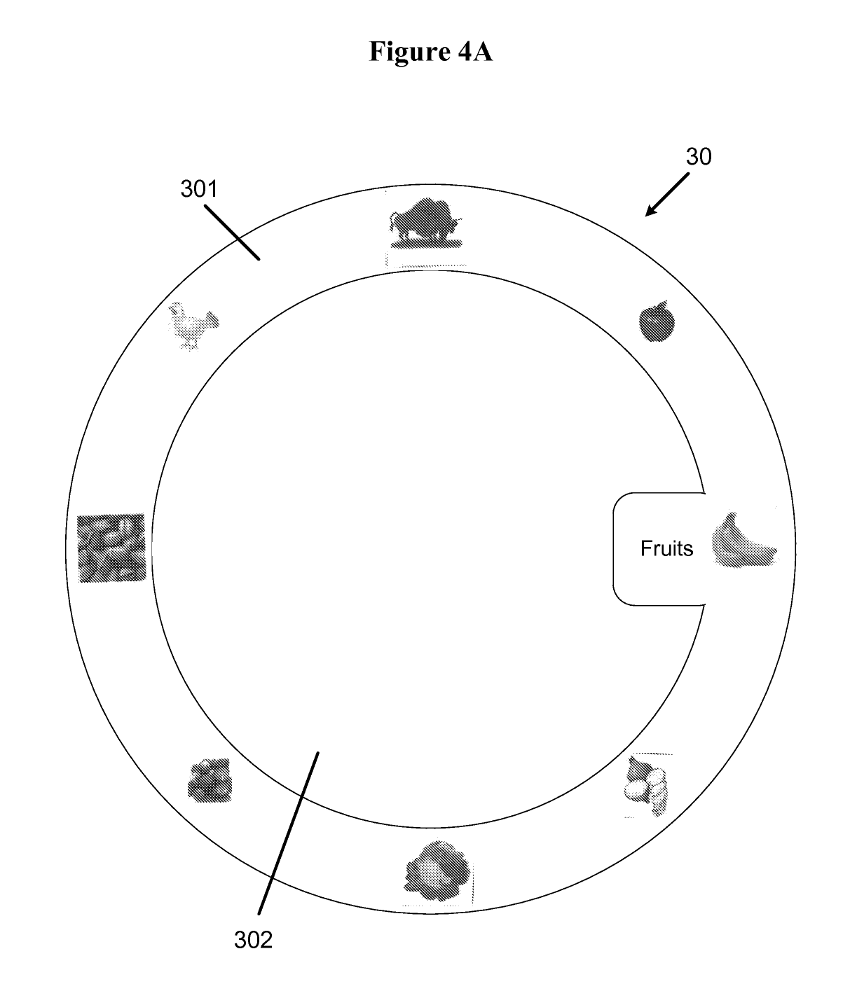

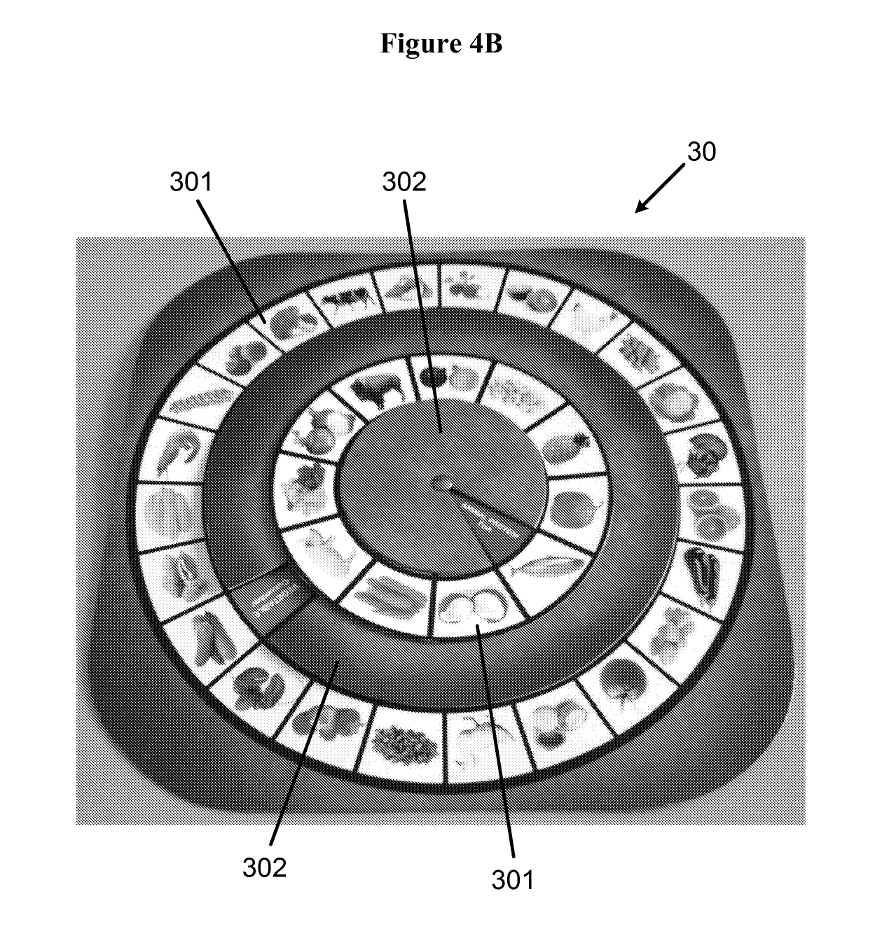

As shown in FIGS. 3A-3B, the game may also include multiple puzzle piece sets 20 (e.g., six puzzle piece sets 20), wherein each puzzle piece set 20 includes a puzzle piece representing fruits 201, a puzzle piece representing vegetables 202, a puzzle piece representing animal proteins 203 and a puzzle piece representing nuts/seeds 204. As in shown in FIGS. 4A-4B, the game may also include an answer key 30 comprising a base 301 that includes one or more of the graphical representations used to represent healthy food items on the healthy food positions 102 of the playing path 10 adjacent a corresponding textual representation of the healthy food types, as well as one or more selective covers 302 configured to conceal textual representations on the base 301. The selective cover(s) 302 may be rotatable, such that a user can selectively reveal the textual representation corresponding to each of the graphical representations on the base 301.

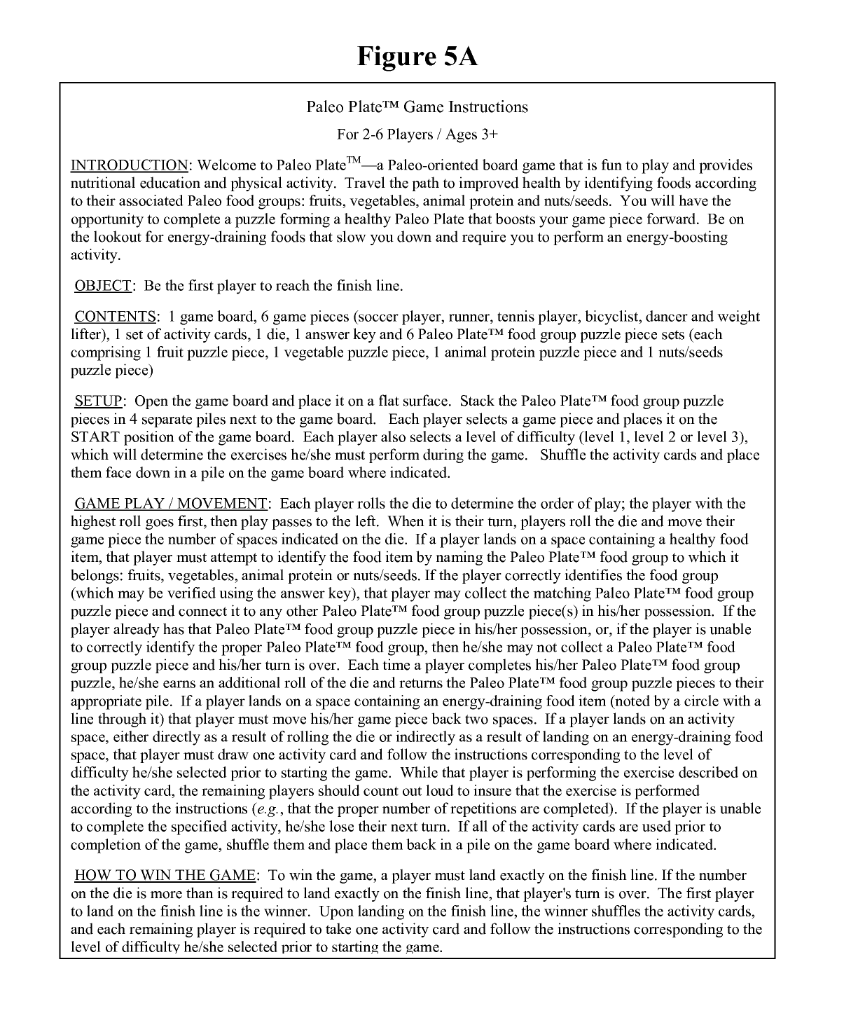

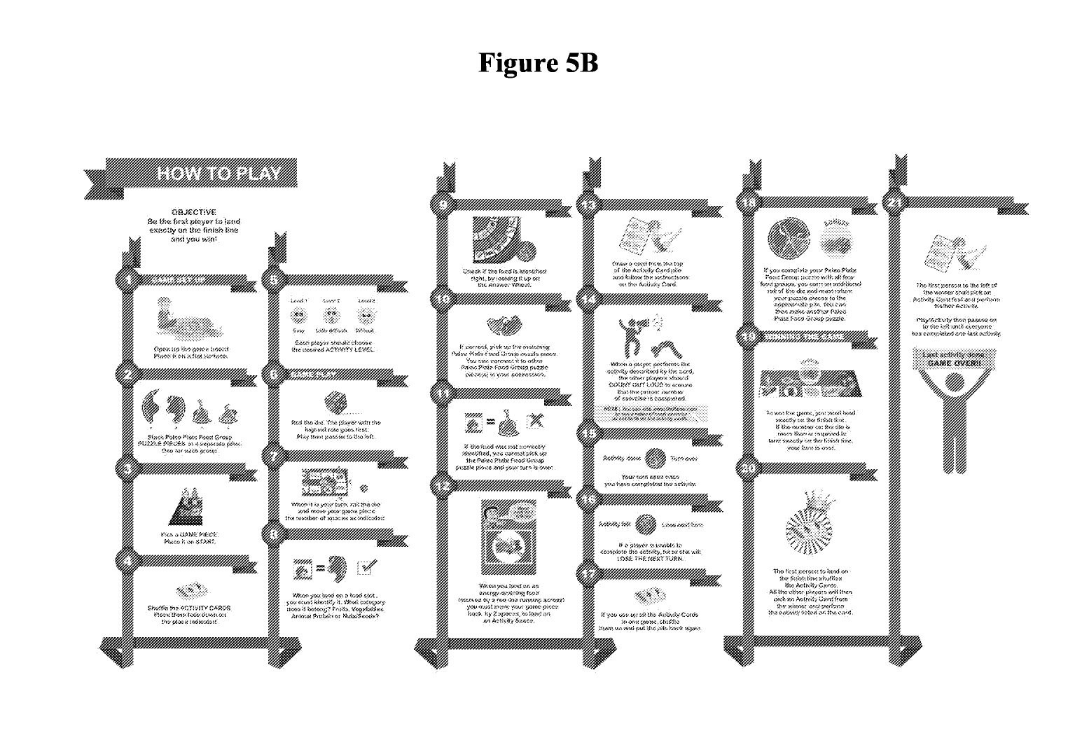

As in shown in FIGS. 5A-5B, the game may also include a set of instructions that directs players how to set up and play the game.

Playing surfaces of the present invention may include any suitable medium. In some embodiments, the playing surface includes a physical playing surface, such as a game board or a mat. In some embodiments, the playing surface includes an electronic playing surface, such as a virtual board or mat encoded by a computer program product on a tangible computer readable storage medium having computer program code embodied in the medium that can be executed by a computer.

Playing paths of the present invention may include any suitable type(s) of positions. In some embodiments, the playing path includes a start position, a goal position, one or more healthy food positions, one or more energy-draining food positions and/or one or more activity positions. Thus, as shown in FIGS. 1A-1B, in some embodiments, the playing path 10 may include a start position 101 and a goal position 105, with multiple healthy food positions 102, multiple energy-draining food positions 103 and multiple activity positions 104 interposed therebetween. In those embodiments comprising multiple types of positions (e.g., healthy food positions, energy-draining food positions and activity positions), the position types may be arranged in any suitable order along the path. For example, in some embodiments, the positions between the start position and the goal position are arranged in a pattern along the playing path (e.g., start, healthy food position, healthy food position, activity position, healthy food position, energy-draining food position, healthy food position, healthy food position, activity position, healthy food position, energy-draining food position, . . . goal). In other embodiments, the positions between the start position and the goal position are arranged in a random or pseudorandom order along the playing path.

Playing paths of the present invention may include any suitable number of positions. In some embodiments, each playing path includes about 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100 or more positions.

Playing paths of the present invention may include any suitable configuration. In some embodiments, each playing path includes multiple positions arranged in a straight path and/or multiple positions arranged in a meandering path. As shown in FIGS. 1A-1B, in some embodiments, a playing path 10 may include both straight portions and meandering portions.

In those embodiments comprising multiple playing paths, the playing paths may be identical or non-identical. For example, in embodiments comprising two playing paths, the two playing paths may have the same order, number and configuration of positions or may differ from one another in one or more of the aforementioned aspects. Similarly, in embodiments comprising three or more playing paths, each of the playing paths may comprise an identical order, number and configuration of positions or one or more of the playing paths may differ from the other playing paths in one or more of the aforementioned aspects.

Healthy food positions of the present invention may represent one or more food types. In some embodiments, each healthy food position on the playing path represents one or more food types selected from the group consisting of dairy products, fruits, vegetables, animal proteins and nuts/seeds. In some embodiments, each healthy food position on the playing path represents one or more food types selected from the group consisting of fruits, vegetables, animal proteins and nuts/seeds. In some embodiments, each healthy food position on the playing path includes a visual representation (e.g., a graphical representation, such as a picture and/or a drawing, or a textual representation, such as a word and/or an abbreviation) of the food type(s) it represents. Thus, in some embodiments, each healthy food position on the playing path includes a graphical representation of one or more fruits, one or more vegetables, one or more animal proteins and/or one or more nuts/seeds.

Healthy food positions of the present invention may include a visual representation of any suitable dairy product, including, but not limited to, fermented dairy products such as butter (e.g., non-pasteurized and/or non-homogenized butter), buttermilk (e.g., non-pasteurized and/or non-homogenized buttermilk), cheese (e.g., raw cheese), clabber, crème fraîche, ghee, Lassi, sour cream (e.g., non-pasteurized and/or non-homogenized sour cream) and yogurt e.g., non-pasteurized and/or non-homogenized yogurt), among others. In some embodiments, one or more of the healthy food positions includes a visual representation of a food item comprising one or more dairy products.

Healthy food positions of the present invention may include a visual representation of any suitable fruit, including, but not limited to, apples, apricots, avocadoes, bananas, blackberries, blueberries, cantaloupes, casaba melons, cherries, coconuts, cranberries, cucumbers, currants, dates, elder berries, figs, grapefruits, grapes, guava, honeydew melons, jackfruit, kiwi, lemons, limes, lychee, mangoes, nectarines, oranges, papayas, peaches, pears, peppers (e.g., bell peppers), persimmons, pineapples, plums, pomegranates, passion fruits, raisins, raspberries, squash (e.g., acorn squash, butternut squash and spaghetti squash), starfruit, strawberries, tangerines, tomatoes and/or watermelons, among others. In some embodiments, one or more of the healthy food positions includes a visual representation of a food item comprising one or more fruits.

Healthy food positions of the present invention may include a visual representation of any suitable vegetable, including, but not limited to, artichoke, asparagus, beans (e.g., green beans), beets, bolt choy, broccoli, cabbage, carrots, celery, chicory, collard greens, dandelion greens, kale, leeks, lettuce, mustard greens, okra, onions, parsnips, peas (e.g., snap peas and snow peas), radishes, rutabaga, spinach, starchy tubers (e.g., potatoes), sweet potatoes, swiss chard, turnip greens, turnips and/or yams, among others. In some embodiments, one or more of the healthy food positions includes a visual representation of a food item comprising one or more vegetables (e.g., a salad).

Healthy food positions of the present invention may include a visual representation of any suitable animal protein, including, but not limited to, abalone, beef, bison, chicken, clam, conch, crab, cuttlefish, duck, eggs (e.g., poultry eggs), emu, fish (e.g., anchovies, bass, bluefish, burbot, capelin, carp, catfish, cisco, cod, croaker, dogfish, dolphinfish, drum, eel, flounder, grouper, haddock, hake, halibut, herring, mackerel, mullet, perch, pike, plaice, Pollock, pompano, radish, rockfish, sablefish, salmon, saury, scad, sea bass, sea trout, shark, sheepshead; smelt, snapper, sole, sprat, sturgeon, sunfish, swordfish, tilapia, trout, tuna, walleye, whitefish, whiting, and wolf fish), goat, goose, Guineafowl, lobster, moose, mussels, octopus, ostrich, oysters, peafowl, periwinkle, pheasant, pigeon, pork, quail, rabbit, reindeer, rhea, scallops, sheep, shrimp, squid, swan, turkey, veal, venison and/or wild boar, among others. In some embodiments, one or more of the healthy food positions includes a visual representation of a food item comprising one or more animal proteins.

Healthy food positions of the present invention may include a visual representation of any suitable nut/seed, including, but not limited to, almonds, Brazil nuts, cashews, chestnuts, flax seed, hazelnuts, macadamia nuts, pecans, pine nuts, pistachios, pumpkin seeds, sesame seeds, sunflower seeds and/or walnuts among others. In some embodiments, one or more of the healthy food positions includes a visual representation of an oil derived from a nut/seed (e.g., sesame oil). In some embodiments, one or more of the healthy food positions includes a visual representation of a food item comprising one or more nuts/seeds.

In some embodiments of the present invention, each of the healthy food positions in a given playing path includes a visual representation of a different food. For example, in some such embodiments, each playing path may include multiple healthy food positions representing fruits, but only one healthy food position that represents apples.

In some embodiments of the present invention, the healthy food positions in a given playing path include visual representations of fruits, vegetables, animal proteins and nuts/seeds in a specified ratio. For example, in some such embodiments, each playing path includes healthy food positions representing fruits, healthy food positions representing vegetables, healthy food positions representing animal proteins and healthy food positions representing nuts/seeds in about a 1:1:1:1 ratio.

Healthy food positions of the present invention may instruct a player whose game piece is situated thereon to identify each type of food it represents and, optionally, to identify each food type within a specified period of time and/or within a specified number of guesses.

Healthy food positions of the present invention may instruct a player whose game piece is situated thereon to identify each type of food it represents within a specified period of time (e.g., about 10, 15, 30, 45, 60 seconds or more).

Healthy food positions of the present invention may instruct a player whose game piece is situated thereon to identify each type of food it represents within a specified number of guesses (e.g., about 1, 2, 3, 4, 5, 6, 7, 8, 9, 10 guesses or more).

Healthy food positions of the present invention may instruct a player whose game piece is situated thereon to identify each type of food it represents within a specified number of guesses (e.g., about 1, 2, 3, 4, 5, 6, 7, 8, 9, 10 guesses or more) and within a specified period of time (e.g., about 10, 15, 30, 45, 60 seconds or more).

Healthy food positions of the present invention may instruct a player who successfully identifies each food type as instructed to perform one or more rewarding activities.

Healthy food positions of the present invention may instruct a player whose game piece is situated thereon and who successfully identifies each food type as instructed to perform any suitable rewarding activity, including, but not limited to, moving his/her game piece forwards along the playing path by a specified number of positions, manipulating the randomizer to determine how many positions his/her game piece is to be moved forwards along the playing path and then moving his/her game piece accordingly and/or taking an extra turn.

Healthy food positions of the present invention may instruct a player whose game piece is situated thereon and who fails to identify each food type as instructed to perform one or more penalizing activities.

Healthy food positions of the present invention may instruct a player whose game piece is situated thereon and who fails to identify each food type as instructed to perform any suitable penalizing activity, including, but not limited to, moving his/her game piece backwards along the playing path by a specified number of positions, manipulating the randomizer to determine how many positions his/her game piece is to be moved backwards along the playing path and then moving his/her game piece accordingly and/or skipping his/her next turn. In some embodiments, one or more of the activity positions directly or indirectly instructs a player whose game piece is situated therein and who fails to perform each of the one or more exercises as instructed to move his/her game piece backwards along the playing path to another activity position and, optionally, to perform one or more exercises as instructed by that activity position.

Healthy food positions of the present invention may instruct a player whose game piece is situated thereon directly or indirectly. That is, each healthy food position may itself provide the instructions for identifying each type of food it represents (with or without instructions as to any specific performance parameters, such as a time limit or a maximum number or guesses), for performing one or more rewarding activities if the represented food type(s) is/are identified as instructed and/or for performing one or more penalizing activities if the represented food type(s) is/are not identified as instructed or it may direct the player to operate a reward selector that provides instructions for performing one or more rewarding activities and/or to a penalty selector that provides instructions for performing one or more penalizing activities. Likewise, each healthy food position may inherently instruct a player whose game piece is situated thereon to identify each type of food it represents (with or without instructions as to any specific performance parameters, such as a time limit or a maximum number or guesses) by virtue of guidelines provided in a set of instructions. Thus, in some embodiments, one or more of the healthy food positions in a playing path may direct a player whose game piece is situated thereon to identify the type(s) of food it represents and, upon successful identification of the food type(s), to select a reward card comprising instructions for performing one or more rewarding activities.

Energy-draining food positions of the present invention may represent one or more food types. In some embodiments, each energy-draining food position on the playing path visually represents one or more food types selected from the group consisting of cereal grains, dairy products, legumes, starchy tubers, refined sugars, and refined vegetable oils. In some embodiments, each energy-draining food position on the playing path includes a visual representation (e.g., a graphical representation, such as a picture and/or a drawing, or a textual representation, such as a word and/or an abbreviation) of the food type(s) it represents. Thus, in some embodiments, each energy-draining food position on the playing path includes a graphical representation of one or more cereal grains, one or more dairy products, one or more legumes, one or more potatoes, one or more processed foods, one or more refined sugars and/or one or more refined vegetable oils.

Energy-draining food positions of the present invention may include a visual representation of any suitable cereal grain, including, but not limited to, barley, corn, millet, oats, rice, rye, sorghum and/or wheat, among others. In some embodiments, one or more of the energy-draining food positions includes a visual representation of a food item comprising one or more cereal grains (e.g., cereal, pretzels, cookies and bagels).

Energy-draining food positions of the present invention may include a visual representation of any suitable dairy product, including, but not limited to, butter, cheese, cream, milk and/or yogurt, among others. In some embodiments, one or more of the energy-draining food positions includes a visual representation of a food item comprising one or more dairy products (e.g., milkshakes and ice cream).

Energy-draining food positions of the present invention may include a visual representation of any suitable legume, including, but not limited to, black beans, black-eyed peas, chickpeas, garbanzo beans, kidney beans, lentils, lima beans, mung beans, peanuts, snow peas, soybeans, string beans and/or sugar snap peas, among others. In some embodiments, one or more of the energy-draining food positions includes a visual representation of a food item comprising one or more legumes.

Energy-draining food positions of the present invention may include a visual representation of any suitable starch tuber, including, but not limited to, potatoes, among others. In some embodiments, one or more of the energy-draining food positions includes a visual representation of a food item comprising one or more starch tubers (e.g., french fries and potato chips).

Energy-draining food positions of the present invention may include a visual representation of any suitable refined sugars, including, but not limited to, candy, fruit juices and/or soft drinks, among others. In some embodiments, one or more of the energy-draining food positions includes a visual representation of a food item comprising one or more refined sugars (e.g., soft drinks, candy bars and cake).

Energy-draining food positions of the present invention may include a visual representation of any suitable refined vegetable oils, including, but not limited to, canola oil, corn oil, cottonseed oil, peanut oil, rapeseed oil, sesame seed oil, soybean oil and/or sunflower seed oil, among others. In some embodiments, one or more of the energy-draining food positions includes a visual representation of a food item comprising one or more refined vegetable oils.

Energy-draining food positions of the present invention may instruct a player whose game piece is situated thereon directly or indirectly. That is, each energy-draining food position may itself provide the instructions for performing one or more penalizing activities or it may direct the player to operate a penalty selector that provides instructions for performing one or more penalizing activities. Likewise, each energy-draining food position may inherently instruct a player whose game piece is situated thereon to one or more penalizing activities by virtue of guidelines provided in a set of instructions.

Energy-draining food positions of the present invention may directly or indirectly instruct a player whose game piece is situated thereon to perform any suitable penalizing activity, including, but not limited to, moving his/her game piece backwards along the playing path by a specified number of positions, manipulating the randomizer to determine how many positions his/her game piece is to be moved backwards along the playing path and then moving his/her game piece accordingly and/or skipping his/her next turn. In some embodiments, one or more of the energy-draining food positions directly or indirectly instructs a player whose game piece is situated therein to move his/her game piece backwards along the playing path to an activity position and, optionally, to perform one or more exercises as instructed by the activity position.

Activity positions of the present invention may include one or more graphical representations of one or more characters (e.g., a photograph or illustration of one or more persons) exercising. In some embodiments, each activity position includes a visual indicator that the position is associated with physical activity (e.g., “Activity”). In some embodiments, each activity position includes a graphical representation of one or more characters (e.g., a photograph or illustration of one or more persons) participating in a physical activity selected from the group consisting of aerobics, archery, badminton, baseball, basketball, calisthenics, canoeing, cheerleading, climbing, cross country skiing, cycling, dancing, football, golf, gymnastics, hiking, hockey, ice skating, jogging, jumping rope, martial arts, rock climbing, rollerblading, rowing, running, soccer, skateboarding, skiing, swimming, tennis, tug-of-war, volleyball, walking, weight lifting, wrestling and/or yoga, among others.

Activity positions of the present invention may instruct a player whose game piece is situated thereon to perform one or more exercises and, optionally, to perform the one or more exercises for a specified duration, within a specified period of time and/or for a specified number of repetitions.

Activity positions of the present invention may instruct a player whose game piece is situated thereon to perform any suitable exercise, including, but not limited to, calisthenics and yoga.

Activity positions of the present invention may instruct a player whose game piece is situated thereon to perform each of the one or more exercises for a specified duration (e.g., about 10, 15, 30, 45, 60, 75, 90, 105, 120, 150, 180, 210, 240, 270, 300 seconds or more). For example, one or more of the activity positions in a playing path may include instructions for performing each of the one or more exercises for 30 seconds, 1 minute or 2 minutes.

Activity positions of the present invention may instruct a player whose game piece is situated thereon to perform each of the one or more exercises within a specified period of time (e.g., about 10, 15, 30, 45, 60, 75, 90, 105, 120, 150, 180, 210, 240, 270, 300 seconds or more). For example, one or more of the activity positions in a playing path may include instructions for performing each of the one or more exercises within 30 seconds, 1 minute or 2 minutes.

Activity positions of the present invention may instruct a player whose game piece is situated thereon to perform each of the one or more exercises for a specified number of repetitions (e.g., about 2, 3, 4, 5, 6, 7, 8, 9, 10, 11, 12, 13, 14, 15, 16, 17, 18, 19, 20, 25, 30, 35, 40, 45, 50 repetitions or more). For example, one or more of the activity positions in a playing path may include instructions for performing each of the one or more exercises for 10, 20 or 30 repetitions.

Activity positions of the present invention may instruct a player whose game piece is situated thereon to perform each of the one or more exercises for a specified number of repetitions (e.g., about 2, 3, 4, 5, 6, 7, 8, 9, 10, 11, 12, 13, 14, 15, 16, 17, 18, 19, 20, 25, 30, 35, 40, 45, 50 repetitions or more) and within a specified period of time (e.g., about 10, 15, 30, 45, 60, 75, 90, 105, 120, 150, 180, 210, 240, 270, 300 seconds or more). For example, one or more of the activity positions in a playing path may include instructions for performing each of the one or more exercises for 10, 20 or 30 repetitions within 30 seconds, 1 minute or 2 minutes.

Activity positions of the present invention may instruct a player whose game piece is situated thereon to perform a given exercise in accordance with one of two or more alternative methods (e.g., 2, 3, 4, 5, 6, 7, 8, 9, 10 or more alternative methods). In some embodiments, each activity position provides instructions for performing an exercise in accordance with three alternative methods and instructs the player to select which method he/she will utilize prior to initiating the exercise. For example, an activity position may include instructions for alternative methods of performing push-ups—with knees resting on the ground, with knees extended in a plank position, with knees extended in a plank position and a clap between each push-up—and may instruct the player to select the method he/she will utilize prior to attempting the first push-up. In some instances, the player is required to select which of the three methods he/she will utilize prior to beginning the game (i.e., to elect the first, second or third method on each activity card prior to beginning the game).

Activity positions of the present invention may instruct a player whose game piece is situated thereon to perform a given exercise in accordance with one of two or more alternative sets of performance parameters (e.g., 2, 3, 4, 5, 6, 7, 8, 9, 10 or more alternative sets). In some embodiments, each activity position provides instructions for performing an exercise in accordance with three alternative sets of performance parameters and instructs the player to select which set of performance parameters he/she will utilize prior to initiating the exercise. For example, an activity position may include instructions for performing lunges according to alternative performance parameters—6 alternating lunges, 8 alternating or 10 alternating lunges—and may instruct the player to select the method he/she will utilize prior to attempting the first lunge. In some instances, the player is required to select which of the three sets of performance parameters he/she will utilize prior to beginning the game (i.e., to elect the first, second or third set of performance parameters on each activity card prior to beginning the game).

Activity positions of the present invention may instruct a player whose game piece is situated thereon to perform a given exercise in accordance with one of two or more alternative methods (e.g., 2, 3, 4, 5, 6, 7, 8, 9, 10 or more alternative methods) and one of two or more alternative sets of performance parameters (e.g., 2, 3, 4, 5, 6, 7, 8, 9, 10 or more alternative sets). In other words, an activity position may instruct a player whose game piece is situated thereon to perform a given exercise in accordance with one of two or more alternative sets of instructions, wherein both the method of performing the exercise and the performance parameters of the exercise vary across the instruction sets. For example, an activity position may include alternative instructions for performing yoga—tree pose for 10 seconds, tree pose for 15 seconds, tree pose for 10 seconds with eyes closed—and may instruct the player to select the method he/she will utilize prior to attempting the pose. In some instances, the player is required to select which of the three sets of instructions he/she will utilize prior to beginning the game (i.e., to elect the first, second or third set of instructions on each activity card prior to beginning the game).

Activity positions of the present invention may instruct a player who successfully performs each of the one or more exercises as instructed to perform one or more rewarding activities.

Activity positions of the present invention may instruct a player who successfully performs each of the one or more exercises as instructed to perform any suitable rewarding activity, including, but not limited to, moving his/her game piece forwards along the playing path by a specified number of positions, manipulating the randomizer to determine how many positions his/her game piece is to be moved forwards along the playing path and then moving his/her game piece accordingly and/or taking an extra turn.

Activity positions of the present invention may instruct a player whose game piece is situated thereon and who fails to perform each of the one or more exercises as instructed to perform one or more penalizing activities.

Activity positions of the present invention may instruct a player whose game piece is situated thereon and who fails to perform each of the one or more exercises as instructed to perform any suitable penalizing activity, including, but not limited to, moving his/her game piece backwards along the playing path by a specified number of positions, manipulating the randomizer to determine how many positions his/her game piece is to be moved backwards along the playing path and then moving his/her game piece accordingly and/or skipping his/her next turn. In some embodiments, one or more of the activity positions directly or indirectly instructs a player whose game piece is situated therein and who fails to perform each of the one or more exercises as instructed to move his/her game piece backwards along the playing path to another activity position and, optionally, to perform one or more exercises as instructed by that activity position.

Activity positions of the present invention may instruct a player whose game piece is situated thereon directly or indirectly. That is, each activity position may itself provide the instructions for performing one or more exercises (with or without instructions as to any specific performance parameters, such as duration, time limit or number or repetitions), for performing one or more rewarding activities if the prescribed exercise(s) is/are performed as instructed and/or for performing one or more penalizing activities if the prescribed exercise(s) is/are not performed as instructed or it may direct the player to operate an activity selector that provides instructions for performing one or more exercises, a reward selector that provides instructions for performing one or more rewarding activities and/or a penalty selector that provides instructions for performing one or more penalizing activities. Likewise, each activity position may inherently instruct a player whose game piece is situated thereon to perform one or more exercises (with or without instructions as to any specific performance parameters, such as duration, time limit or number or repetitions), to perform one or more rewarding activities if the prescribed exercise(s) is/are performed as instructed and/or to perform one or more penalizing activities if the prescribed exercise(s) is/are not performed as instructed by virtue of guidelines provided in a set of instructions. Thus, in some embodiments, one or more of the activity positions in a playing path may direct a player whose game piece is situated thereon to select an activity card comprising instructions for performing one or more exercises and, upon successful completion of the prescribed exercise(s), to select a reward card comprising instructions for performing one or more rewarding activities.

Game pieces of the present invention may comprise any suitable device that is operable to move along a playing path. In some embodiments, the game piece is a physical game piece, such as a token or figurine. In some embodiments, the game piece is an electronic game piece, such as an icon encoded by a computer program product on a tangible computer readable storage medium having computer program code embodied in the medium that can be executed by a computer.

Game pieces of the present invention may include a graphical representation of one or more characters (e.g., a photograph or illustration of one or more persons) participating in a physical activity. In some embodiments, each game piece includes a graphical representation of one or more persons participating in a physical activity selected from the group consisting of aerobics, archery, badminton, baseball, basketball, calisthenics, canoeing, cheerleading, climbing, cross country skiing, cycling, dancing, football, golf, gymnastics, hiking, hockey, ice skating, jogging, jumping rope, martial arts, rock climbing, rollerblading, rowing, running, soccer, skateboarding, skiing, swimming, tennis, tug-of-war, volleyball, walking, weight lifting, wrestling and/or yoga, among others. In some embodiments, each game piece includes a figurine of one or more persons participating in a physical activity. Thus, in some embodiments, each game piece includes a figurine of one or more persons participating in a physical activity selected from the group consisting of aerobics, archery, badminton, baseball, basketball, calisthenics, canoeing, cheerleading, climbing, cross country skiing, cycling, dancing, football, golf, gymnastics, hiking, hockey, ice skating, jogging, jumping rope, martial arts, rock climbing, rollerblading, rowing, running, soccer, skateboarding, skiing, swimming, tennis, tug-of-war, volleyball, walking, weight lifting, wrestling and yoga, among others.

Randomizers of the present invention may be configured to determine whether and/or how far a game piece is to be advanced along a playing path. In some embodiments, the randomizer is configured to determine how many positions a player may advance his/her game piece along a playing path at the outset of his/her turn. In some embodiments, the randomizer is configured to determine how many positions a player may move his/her game piece forwards along a playing path as a reward. In some embodiments, the randomizer is configured to determine how many positions a player must move his/her game piece backwards along a playing path as a penalty.

Randomizers of the present invention may include any suitable chance determining device, technique, operation and/or method known in the art. In some embodiments, the randomizer includes a manual chance determining device, such as one or more die (e.g., one or more standard six-sided die), multiple cards (e.g., multiple cards comprising instructions for moving a game piece forward or backward along the playing path a specified number of positions) and/or a spinner (e.g., a device comprising an arrow that may be rotated about an axis to select a labeled portion of a circle disposed thereunder, wherein each labeled portion of the circle disposed thereunder includes instructions of moving a game piece forward or backward along the playing path a specified number of positions). In some embodiments, the randomizer includes an electronic chance determining device, such as an electronic device configured to randomly generate an indicator of the number of positions a player is to advance his/her game piece along a playing path.

Activity selectors of the present invention may include any suitable device, technique, operation and/or method for selecting one or more exercises and/or for selecting one or more performance parameters (e.g., duration, time limit, number of repetitions, etc). In some embodiments, the activity selector includes a manual device, such as one or more die (e.g., one die comprising a visual representation of an exercise on each face thereof and one die comprising at least one exercise parameter on each face thereof), multiple cards (e.g., multiple cards comprising instructions for performing various exercises) and/or a spinner (e.g., a device comprising an arrow that may be rotated about an axis to select a labeled portion of a circle disposed thereunder, wherein each labeled portion of the circle disposed thereunder includes instructions for performing one or more exercises). In some embodiments, the activity selector includes an electronic device configured to select (e.g., randomly select) one or more exercises and/or one or more performance parameters.

Activity selectors of the present invention may include multiple activity cards, wherein each activity card includes instructions for performing one or more exercises (with or without instructions as to any specific performance parameters, such as duration, time limit or number or repetitions). In some embodiments, each activity card further includes a graphical representation of one or more characters (e.g., a photograph or illustration of one or more persons) exercising (e.g., performing one or more of the physical activities for which instructions are provided).

Activity selectors of the present invention may instruct a player to perform any suitable exercise, including, but not limited to, calisthenics and/or yoga, among others. For example, in those embodiments comprising multiple activity cards, one or more of the activity cards may include instructions for performing one or more exercises selected from the group consisting of burpees, calf-raises, crunches, flutter kicks, front kicks, jumping jacks, lunges, mountain climbers, push-ups, sit-ups, squats, star jumps and/or yoga, among others.

Activity selectors of the present invention may instruct a player to perform each of the one or more exercises for a specified duration (e.g., about 10, 15, 30, 45, 60, 75, 90, 105, 120, 150, 180, 210, 240, 270, 300 seconds or more). For example, in those embodiments comprising multiple activity cards, one or more of the activity cards may include instructions for performing each of the one or more exercises for 30 seconds, 1 minute or 2 minutes.

Activity selectors of the present invention may instruct a player to perform each of the one or more exercises within a specified period of time (e.g., about 10, 15, 30, 45, 60, 75, 90, 105, 120, 150, 180, 210, 240, 270, 300 seconds or more). For example, in those embodiments comprising multiple activity cards, one or more of the activity cards may include instructions for performing each of the one or more exercises within 30 seconds, 1 minute or 2 minutes.

Activity selectors of the present invention may instruct a player to perform each of the one or more exercises for a specified number of repetitions (e.g., about 2, 3, 4, 5, 6, 7, 8, 9, 10, 11, 12, 13, 14, 15, 16, 17, 18, 19, 20, 25, 30, 35, 40, 45, 50 repetitions or more). For example, in those embodiments comprising multiple activity cards, one or more of the activity cards may include instructions for performing each of the one or more exercises for 10, 20 or 30 repetitions.

Activity selectors of the present invention may instruct a player to perform each of the one or more exercises for a specified number of repetitions (e.g., about 2, 3, 4, 5, 6, 7, 8, 9, 10, 11, 12, 13, 14, 15, 16, 17, 18, 19, 20, 25, 30, 35, 40, 45, 50 repetitions or more) and within a specified period of time (e.g., about 10, 15, 30, 45, 60, 75, 90, 105, 120, 150, 180, 210, 240, 270, 300 seconds or more). For example, in those embodiments comprising multiple activity cards, one or more of the activity cards may include instructions for performing each of the one or more exercises for 10, 20 or 30 repetitions within 30 seconds, 1 minute or 2 minutes.

Activity selectors of the present invention may instruct a player to perform a given exercise in accordance with one of two or more alternative methods (e.g., 2, 3, 4, 5, 6, 7, 8, 9, 10 or more alternative methods). In some embodiments, the activity selector provides instructions for performing an exercise in accordance with three alternative methods and instructs the player to select which method he/she will utilize prior to initiating the exercise. For example, an activity card may include instructions for alternative methods of performing push-ups—with knees resting on the ground, with knees extended in a plank position, with knees extended in a plank position and a clap between each push-up—and may instruct the player to select the method he/she will utilize prior to attempting the first push-up. In some instances, the player is required to select which of the three methods he/she will utilize prior to beginning the game (i.e., to elect the first, second or third method on each activity card prior to beginning the game).

Activity selectors of the present invention may instruct a player to perform a given exercise in accordance with one of two or more alternative sets of performance parameters (e.g., 2, 3, 4, 5, 6, 7, 8, 9, 10 or more alternative sets). In some embodiments, the activity selector provides instructions for performing an exercise in accordance with three alternative sets of performance parameters and instructs the player to select which set of performance parameters he/she will utilize prior to initiating the exercise. For example, an activity card may include instructions for performing lunges according to alternative performance parameters—6 alternating lunges, 8 alternating or 10 alternating lunges—and may instruct the player to select the method he/she will utilize prior to attempting the first lunge. In some instances, the player is required to select which of the three sets of performance parameters he/she will utilize prior to beginning the game (i.e., to elect the first, second or third set of performance parameters on each activity card prior to beginning the game).

Activity selectors of the present invention may instruct a player to perform a given exercise in accordance with one of two or more alternative methods (e.g., 2, 3, 4, 5, 6, 7, 8, 9, 10 or more alternative methods) and one of two or more alternative sets of performance parameters (e.g., 2, 3, 4, 5, 6, 7, 8, 9, 10 or more alternative sets). In other words, the activity selector may instruct a player whose game piece is situated thereon to perform a given exercise in accordance with one of two or more alternative sets of instructions, wherein both the method of performing the exercise and the performance parameters of the exercise vary across the instruction sets. For example, an activity card may include alternative instructions for performing yoga—tree pose for 10 seconds, tree pose for 15 seconds, tree pose for 10 seconds with eyes closed—and may instruct the player to select the method he/she will utilize prior to attempting the pose. In some instances, the player is required to select which of the three sets of instructions he/she will utilize prior to beginning the game (i.e., to elect the first, second or third set of instructions on each activity card prior to beginning the game).

Activity selectors of the present invention may instruct a player who successfully performs each of the one or more exercises as instructed to perform one or more rewarding activities. For example, in those embodiments comprising multiple activity cards, one or more of the activity cards may include instructions for performing a penalizing activity if each of the one or more exercises is not performed as instructed.

Activity selectors of the present invention may instruct a player who successfully performs each of the one or more exercises as instructed to perform any suitable rewarding activity, including, but not limited to, moving his/her game piece forwards along the playing path by a specified number of positions, manipulating the randomizer to determine how many positions his/her game piece is to be moved forwards along the playing path and then moving his/her game piece accordingly and/or taking an extra turn.

Activity selectors of the present invention may instruct a player who fails to perform each of the one or more exercises as instructed to perform one or more penalizing activities. For example, in those embodiments comprising multiple activity cards, one or more of the activity cards may include instructions for performing each of the one or more penalizing activities if each of the one or more exercises is not performed as instructed.

Activity selectors of the present invention may instruct a player who fails to perform each of the one or more exercises as instructed to perform any suitable penalizing activity, including, but not limited to, moving his/her game piece backwards along the playing path by a specified number of positions, manipulating the randomizer to determine how many positions his/her game piece is to be moved backwards along the playing path and then moving his/her game piece accordingly and/or skipping his/her next turn. In some embodiments, one or more of the activity selectors instructs a player who fails to perform each of the one or more exercises as instructed to move his/her game piece backwards along the playing path to another activity position and, optionally, to perform one or more exercises as required by that activity position.

Activity selectors of the present invention may instruct a player directly or indirectly. That is, each activity selector may itself provide the instructions for performing one or more rewarding activities if the prescribed exercise(s) is/are performed as instructed and/or for performing one or more penalizing activities if the prescribed exercise(s) is/are not performed as instructed or it may direct the player to operate a reward selector that provides instructions for performing one or more rewarding activities and/or a penalty selector that provides instructions for performing one or more penalizing activities. Likewise, each activity selector may inherently instruct a player to perform one or more rewarding activities if the prescribed exercise(s) is/are performed as instructed and/or to perform one or more penalizing activities if the prescribed exercise(s) is/are not performed as instructed by virtue of guidelines provided in a set of instructions. Thus, in some embodiments, one or more of the activity selectors in a game may direct a player to perform one or more exercises and, upon successful completion of the prescribed exercise(s), to select a reward card comprising instructions for performing one or more rewarding activities.

Puzzle pieces of the present invention may represent one or more food types. In some embodiments, each puzzle piece represents one or more food types selected from the group consisting of dairy products, fruits, vegetables, animal proteins and nuts/seeds. In some embodiments, each puzzle piece represents one or more food types selected from the group consisting of fruits, vegetables, animal proteins and nuts/seeds. In some embodiments, each puzzle piece includes a visual representation (e.g., a graphical representation, such as a picture and/or a drawing, or a textual representation, such as a word and/or an abbreviation) of the food type(s) it represents. Thus, in some embodiments, each puzzle piece includes a graphical representation of one or more fruits, one or more vegetables, one or more animal proteins and/or one or more nuts/seeds.

Puzzle pieces of the present invention may include a visual representation of any suitable dairy product, including, but not limited to, fermented dairy products such as butter (e.g., non-pasteurized and/or non-homogenized butter), buttermilk (e.g., non-pasteurized and/or non-homogenized buttermilk), cheese (e.g., raw cheese), clabber, crème fraîche, ghee, Lassi, sour cream (e.g., non-pasteurized and/or non-homogenized sour cream) and yogurt e.g., non-pasteurized and/or non-homogenized yogurt), among others. In some embodiments, one or more of the puzzle pieces includes a visual representation of a food item comprising one or more dairy products.

Puzzle pieces of the present invention may include a visual representation of any suitable fruit, including, but not limited to, apples, apricots, avocadoes, bananas, blackberries, blueberries, cantaloupes, casaba melons, cherries, coconuts, cranberries, cucumbers, currants, dates, elder berries, figs, grapefruits, grapes, guava, honeydew melons, jackfruit, kiwi, lemons, limes, lychee, mangoes, nectarines, oranges, papayas, peaches, pears, peppers (e.g., bell peppers), persimmons, pineapples, plums, pomegranates, passion fruits, raisins, raspberries, squash (e.g., acorn squash, butternut squash and spaghetti squash), starfruit, strawberries, tangerines, tomatoes and/or watermelons, among others. In some embodiments, one or more of the puzzle pieces includes a visual representation of a food item comprising one or more fruits.

Puzzle pieces of the present invention may include a visual representation of any suitable vegetable, including, but not limited to, artichoke, asparagus, beans (e.g., green beans), beets, bok choy, broccoli, cabbage, carrots, celery, chicory, collard greens, dandelion greens, kale, leeks, lettuce, mustard greens, okra, onions, parsnips, peas (e.g., snap peas and snow peas), radishes, rutabaga, spinach, starchy tubers (e.g., potatoes), sweet potatoes, swiss chard, turnip greens, turnips and/or yams, among others. In some embodiments, one or more of the puzzle pieces includes a visual representation of a food item comprising one or more vegetables (e.g., a salad).

Puzzle pieces of the present invention may include a visual representation of any suitable animal protein, including, but not limited to, abalone, beef, bison, chicken, clam, conch, crab, cuttlefish, duck, eggs (e.g., poultry eggs), emu, fish (e.g., anchovies, bass, bluefish, burbot, capelin, carp, catfish, cisco, cod, croaker, dogfish, dolphinfish, drum, eel, flounder, grouper, haddock, hake, halibut, herring, mackerel, mullet, perch, pike, plaice, Pollock, pompano, ratfish, rockfish, sablefish, salmon, saury, scad, sea bass, sea trout, shark, sheepshead, smelt, snapper, sole, sprat, sturgeon, sunfish, swordfish, tilapia, trout, tuna, walleye, whitefish, whiting, and wolf fish), goat, goose, Guineafowl, lobster, moose, mussels, octopus, ostrich, oysters, peafowl, periwinkle, pheasant, pigeon, pork, quail, rabbit, reindeer, rhea, scallops, sheep, shrimp, squid, swan, turkey, veal, venison and/or wild boar, among others. In some embodiments, one or more of the puzzle pieces includes a visual representation of a food item comprising one or more animal proteins.

Puzzle pieces of the present invention may include a visual representation of any suitable nut/seed, including, but not limited to, almonds, Brazil nuts, cashews, chestnuts, flax seed, hazelnuts, macadamia nuts, pecans, pine nuts, pistachios, pumpkin seeds, sesame seeds, sunflower seeds and/or walnuts, among others. In some embodiments, one or more of the healthy food positions includes a visual representation of an oil derived from a nut/seed (e.g., sesame oil). In some embodiments, one or more of the puzzle pieces includes a visual representation of a food item comprising one or more nuts/seeds.

In some embodiments, one or more of the healthy food positions on a playing path may instruct a player whose game piece is situated thereon and who correctly identifies which food type is represented thereby to select a puzzle piece (e.g., a puzzle piece that represents the food type represented by the healthy food position).

Puzzle pieces of the present invention may fit together to form one or more puzzle piece sets. In some embodiments, each puzzle piece set includes one or more puzzle pieces representing each of multiple food types (e.g., fruits, vegetables, animal proteins and nuts/seeds). In some embodiments, each puzzle piece set includes one or more puzzle pieces comprising a visual representation (e.g., a graphical representation, such as a picture and/or a drawing, or a textual representation, such as a word and/or an abbreviation) of the food type(s) it represents. Thus, in some embodiments, each puzzle piece set includes one or more puzzle pieces comprising a graphical representation of one or more fruits, one or more puzzle pieces comprising a graphical representation of one or more vegetables, one or more puzzle pieces comprising a graphical representation of one or more animal proteins and one or more puzzle pieces comprising a graphical representation of one or more nuts/seeds.

Puzzle piece sets of the present invention may include puzzle pieces representing fruits, vegetables, animal proteins and nuts/seeds in a specified ratio. In some embodiments, each puzzle piece set includes puzzle pieces representing fruits, puzzle pieces representing vegetables, puzzle pieces representing animal proteins and puzzle pieces representing nuts/seeds in about a 1:1:1:1 ratio.

Each puzzle piece in a puzzle piece set may include a visual representation of a different food type. In some embodiments, each puzzle set may include four puzzle pieces, with each puzzle piece representing one food type selected from the group consisting of fruits, vegetables, animal proteins and nuts/seeds.

Puzzle piece sets of the present invention may instruct a player who acquires each puzzle piece in the puzzle piece set to perform one or more rewarding activities.

Puzzle piece sets of the present invention may instruct a player who acquires each puzzle piece in the puzzle piece set to perform any suitable exercise, including, but not limited to, moving his/her game piece forwards along the playing path by a specified number of positions, manipulating the randomizer to determine how many positions his/her game piece is to be moved forwards along the playing path and then moving his/her game piece accordingly and/or taking an extra turn.

Puzzle piece sets of the present invention may instruct a player who acquires each puzzle piece in the puzzle piece set directly or indirectly. That is, each puzzle piece set may itself provide the instructions for performing rewarding activities if the prescribed exercise(s) is/are performed as instructed or it may direct the player to operate reward selector that provides instructions for performing one or more rewarding activities. Likewise, each puzzle piece set may inherently instruct a player who acquires each puzzle piece in the puzzle piece set to perform one or more rewarding activities by virtue of guidelines provided in a set of instructions. Thus, in some embodiments, one or more of the puzzle piece sets may direct a player who acquires each puzzle piece in the puzzle piece set to select a reward card comprising instructions for performing one or more rewarding activities.

Answer keys of the present invention may include any suitable means of identifying which food type(s) is/are represented by the healthy food positions and/or energy-draining food positions in a playing path.

In some embodiments, the answer key includes a manual means of identifying which food type(s) is/are represented by the healthy food positions and/or energy-draining food positions in a playing path. For example, the answer key may include as a paper or booklet comprising a chart wherein the name of each food type represented on a healthy food position (e.g., “Fruits”) is associated with the corresponding graphical representation(s) used to represent that food type. Similarly, the answer key may include multiple cards wherein the name of each food type represented on a healthy food position (e.g., “Fruits”) is presented on a card comprising the graphical representation(s) used to represent that food type. Likewise, the answer key may include a sliding tab apparatus comprising a base and multiple sliding tabs having an extended position and a retracted position, wherein each graphical representation used to represent a healthy food type on a healthy food position is presented on the base adjacent the name of the food type it represents (e.g., “Fruits”) and wherein each of the plurality of sliding tabs covers a portion of the base adjacent one of the graphical representations such that, when in the extended position, each sliding tab covers the name of the food type represented by the adjacent graphical representation. Moreover, the answer key may include a selective wheel comprising a base and a selective cover, wherein the graphical representation(s) used to represent each food type is/are presented along the outer perimeter of the base, wherein the name of each food type (e.g., “Fruits”) is presented adjacent the corresponding graphical representation(s) along the inner perimeter of the base, wherein the selective cover is positioned atop the base such that it prevents the user from seeing the name of the food type corresponding to all but one of the graphical representations and wherein the selective cover is rotatable such that the user can selectively reveal the name corresponding to each of the graphical representations.

In some embodiments, the answer key includes an electronic device configured to selectively reveal which food type(s) is/are represented by the healthy food positions and/or energy-draining food positions in a playing path.

Reward selectors of the present invention may include any suitable means of selecting one or more rewarding activities. In some embodiments, the reward selector includes a manual means of selection, such as one or more die (e.g., a die comprising a graphical representation of a reward on each face thereof), multiple cards (e.g., multiple cards comprising instructions for performing various rewarding activities) and/or a spinner (e.g., a device comprising an arrow that may be rotated about an axis to select a labeled portion of a circle disposed thereunder, wherein each labeled portion of the circle disposed thereunder includes instructions for performing one or more rewarding activities). In some embodiments, the reward selector includes an electronic device configured to select (e.g., randomly select) one or more rewarding activities.

Penalty selectors of the present invention may include any suitable device, technique, operation and/or method for selecting one or more penalizing activities. In some embodiments, the penalty selector includes a manual device, such as one or more die (e.g., a die comprising a graphical representation of a penalty on each face thereof), multiple cards (e.g., multiple cards comprising instructions for performing various penalizing activities) and/or a spinner (e.g., a device comprising an arrow that may be rotated about an axis to select a labeled portion of a circle disposed thereunder, wherein each labeled portion of the circle disposed thereunder includes instructions for performing one or more penalizing activities). In some embodiments, the penalty selector includes an electronic device configured to select (e.g., randomly select) one or more penalizing activities.

Sets of instructions of the present invention may include any suitable device, technique, operation and/or method for conveying information (e.g., the rules of the game, such as when a player is to perform a rewarding/penalizing activity and which rewarding/penalizing activity is to be performed) to a player. In some embodiments, the set of instructions includes a paper or booklet. In some embodiments, the set of instructions includes an electronic device configured to convey information to a player.

Games of the present invention may be embodied in any suitable medium. In some embodiments, the game is a board game comprising a physical playing surface, such as a game board or a mat. In some embodiments, the game is an electronic game comprising a computer program product on a tangible computer readable storage medium having computer program code embodied in the medium that can be executed by a computer.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network or a wide area network, or the connection may be made to an external computer (for example, through the Internet using an Internet Service Provider) or in a cloud computer environment or offered as a service such as a Software as a Service.

As noted above, the present invention also provides methods for teaching healthy eating and exercise habits. In some embodiments, the present invention provides methods for playing a game of the present invention.

Methods of the present invention may include advancing a game piece (e.g., a game piece of the present invention) along a playing path (e.g., a playing path of the present invention). In some embodiments, the methods also include manipulating a randomizer (e.g., a randomizer of the present invention) to determine how many positions the game piece is to be advanced along the playing path.

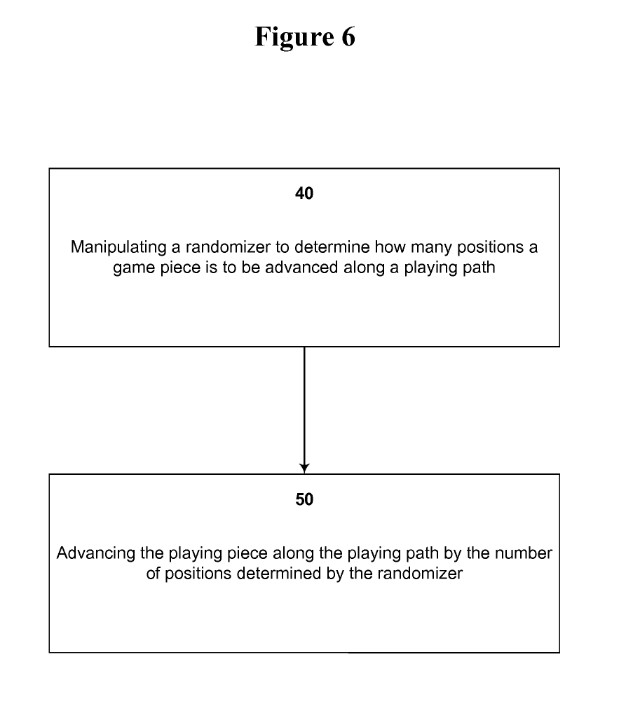

As shown in FIG. 6, in some embodiments of the present invention, the methods may include 40 manipulating a randomizer to determine how many positions a game piece is to be advanced along a playing path comprising multiple healthy food positions, multiple energy-draining food positions and multiple activity positions and 50 advancing the game piece along the playing path by the number of positions determined by the randomizer.

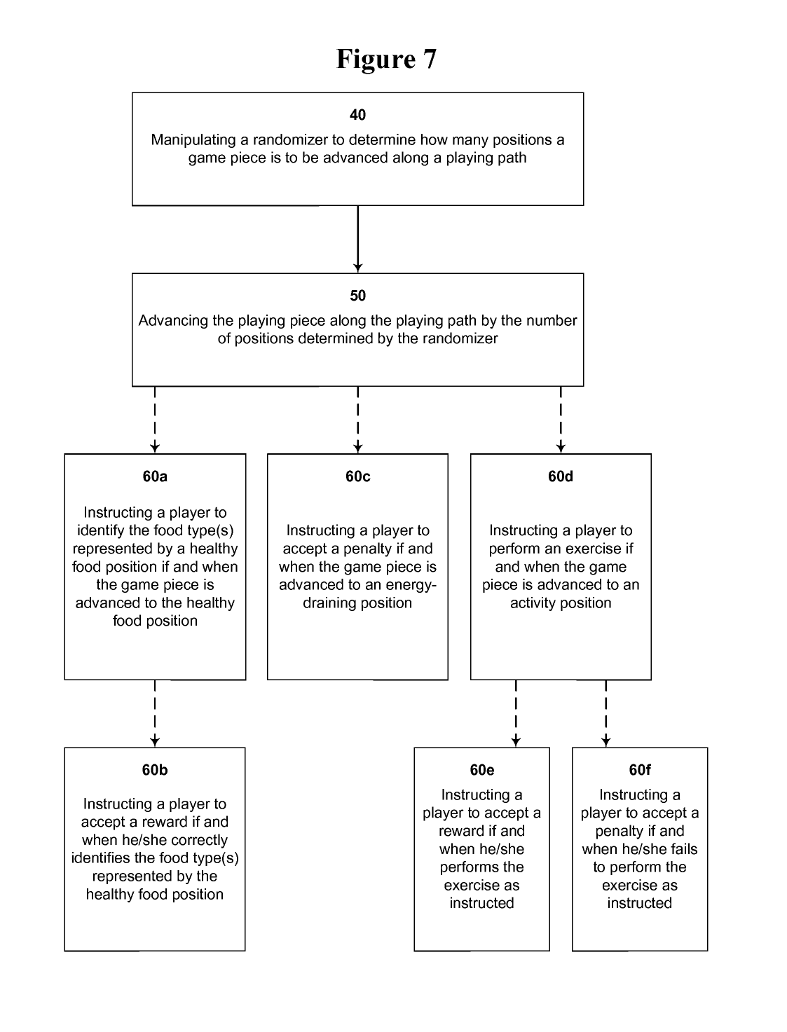

As shown in FIG. 7, in some embodiments of the present invention, the methods also include 60a instructing a player to identify the food type(s) represented by a healthy food position (e.g., if and when the game piece is advanced along the playing path to that healthy food position), 60b instructing a player to accept a reward if and when he/she correctly identifies the food type(s) represented by a healthy food position, 60c instructing a player to accept a penalty if and when the game piece is advanced along the playing path to an energy-draining food position, 60d instructing a player to perform an exercise if and when the game piece is advanced along the playing path to an activity position, 60e instructing a player to accept a reward if and when he/she performs an exercise as instructed and/or 60f instructing a player to accept a penalty if and when he/she fails to perform an exercise as instructed.

In some embodiments, methods of the present invention comprise advancing a game piece along a playing path that includes multiple healthy food positions (e.g., healthy food positions of the present invention), wherein each of the plurality of healthy food positions represents a food type selected from the group consisting of fruits, vegetables, animal proteins and nuts/seeds. In such embodiments, a player whose game piece is advanced to a healthy food position may be required to identify whether the healthy food position represents a fruit, a vegetable, an animal protein or a nut/seed.

Upon correctly identifying whether the healthy food position represents a fruit, a vegetable, an animal protein or a nut/seed, the player may be given a first reward. For example, the player may be given a puzzle piece (e.g., a puzzle piece that represents the food type represented by the healthy food position to which the game piece was advanced). If the player collects each puzzle piece in a puzzle piece set (e.g., each puzzle piece representing fruits, each puzzle piece representing vegetables, each puzzle piece representing animal proteins and each puzzle piece representing nuts/seeds), he/she may be given a second reward. For example, the player may be given an opportunity to advance his/her game piece further along the playing path (e.g., by a specified number of positions and/or by a number of positions determined by manipulating the randomizer).

In some embodiments, methods of the present invention comprise advancing a game piece along a playing path that includes multiple energy-draining food positions (e.g., energy-draining food positions of the present invention). In such embodiments, a player whose game piece is advanced to an energy-draining food position may be given a first penalty. For example, the player may be required to move his/her game piece backwards along the playing path (e.g., by a specified number of positions and/or by a number of positions determined by manipulating the randomizer) and/or may be required to skip his/her next turn. In some embodiments, the player is required to move his/her game piece backwards along the playing path to an activity position (e.g., the activity position immediately preceding the energy-draining food position to which the game piece was advanced).

In some embodiments, methods of the present invention comprise advancing a game piece along a playing path that includes multiple activity positions (e.g., activity positions of the present invention). In such embodiments, a player whose game piece is advanced to an activity position may be instructed to perform one or more exercises. In some such embodiments, the instructions are derived from an activity selector (e.g., an activity selector of the present invention).

The player may be instructed to perform any suitable exercise, including, but not limited to, calisthenics and yoga.

The player may be instructed to perform each of the one or more exercises in accordance with any suitable performance parameters. Thus, the player may be instructed to perform each of the one or more exercises for a specified duration (e.g., about 10, 15, 30, 45, 60, 75, 90, 105, 120, 150, 180, 210, 240, 270, 300 seconds or more), within a specified period of time (e.g., about 10, 15, 30, 45, 60, 75, 90, 105, 120, 150, 180, 210, 240, 270, 300 seconds or more) and/or for a specified number of repetitions (e.g., about 2, 3, 4, 5, 6, 7, 8, 9, 10, 11, 12, 13, 14, 15, 16, 17, 18, 19, 20, 25, 30, 35, 40, 45, 50 repetitions or more).

The player may be instructed to perform each of the one or more exercises for a specified duration (e.g., about 10, 15, 30, 45, 60, 75, 90, 105, 120, 150, 180, 210, 240, 270, 300 seconds or more). For example, the player may be instructed to perform each of the one or more exercises for 30 seconds, 1 minute or 2 minutes.

The player may be instructed to perform each of the one or more exercises within a specified period of time (e.g., about 10, 15, 30, 45, 60, 75, 90, 105, 120, 150, 180, 210, 240, 270, 300 seconds or more). For example, the player may be instructed to perform each of the one or more exercises within 30 seconds, 1 minute or 2 minutes.

The player may be instructed to perform each of the one or more exercises for a specified number of repetitions (e.g., about 2, 3, 4, 5, 6, 7, 8, 9, 10, 11, 12, 13, 14, 15, 16, 17, 18, 19, 20, 25, 30, 35, 40, 45, 50 repetitions or more). For example, the player may be instructed to perform each of the one or more exercises for 10, 20 or 30 repetitions. The player may be instructed to perform each of the one or more exercises for a specified number of repetitions (e.g., about 2, 3, 4, 5, 6, 7, 8, 9, 10, 11, 12, 13, 14, 15, 16, 17, 18, 19, 20, 25, 30, 35, 40, 45, 50 repetitions or more) and within a specified period of time (e.g., about 10, 15, 30, 45, 60, 75, 90, 105, 120, 150, 180, 210, 240, 270, 300 seconds or more). For example, the player may be instructed to perform each of the one or more exercises for 10, 20 or 30 repetitions within 30 seconds, 1 minute or 2 minutes.

The player may be given the option to perform a given exercise in accordance with two or more alternative methods (e.g., 2, 3, 4, 5, 6, 7, 8, 9, 10 or more alternative methods). In some embodiments, the player is given the option to perform an exercise in accordance with three alternative methods and is instructed to select which method he/she will utilize prior to initiating the exercise. For example, the player may be given the option to perform push-ups according to three alternative methods—with knees resting on the ground, with knees extended in a plank position, with knees extended in a plank position and a clap between each push-up—and may be required to select the method he/she will utilize prior to attempting the first push-up. In some instances, the player is required to select which of the three methods he/she will utilize prior to beginning the game (i.e., to elect the first, second or third method on each activity card prior to beginning the game).

The player may be given the option to perform a given exercise in accordance with two or more alternative sets of performance parameters (e.g., 2, 3, 4, 5, 6, 7, 8, 9, 10 or more alternative sets). In some embodiments, the player is given the option to perform an exercise in accordance with three alternative sets of performance parameters and is instructed to select which set of performance parameters he/she will utilize prior to initiating the exercise. For example, the player may be given the option to perform lunges according to three alternative sets of performance parameters—6 alternating lunges, 8 alternating or 10 alternating lunges—and may be required to select the method he/she will utilize prior to attempting the first lunge. In some instances, the player is required to select which of the three sets of performance parameters he/she will utilize prior to beginning the game (i.e., to elect the first, second or third set of performance parameters on each activity card prior to beginning the game).

The player may be given the option to perform a given exercise in accordance with two or more alternative methods (e.g., 2, 3, 4, 5, 6, 7, 8, 9, 10 or more alternative methods) and two or more alternative sets of performance parameters (e.g., 2, 3, 4, 5, 6, 7, 8, 9, 10 or more alternative sets). In other words, the player may be given the option to vary both the method of performing the exercise and the performance parameters of the exercise. For example, the player may be given the option to perform a yoga pose according to three alternative sets of instructions—tree pose for 10 seconds, tree pose for 15 seconds, tree pose for 10 seconds with eyes closed—and may be required to select the method he/she will utilize prior to attempting the pose. In some instances, the player is required to select which of the three sets of instructions he/she will utilize prior to beginning the game (i.e., to elect the first, second or third set of instructions on each activity card prior to beginning the game).

Upon successfully completing each of the one or more exercises as instructed, the player may be given a third reward. For example, the player may be given an opportunity to advance his/her game piece further along the playing path (e.g., by a specified number of positions and/or by a number of positions determined by manipulating the randomizer).

If the player fails to perform each of the one or more exercises as instructed, the player may be given a second penalty. For example, the player may be required to move his/her game piece backwards along the playing path (e.g., by a specified number of positions and/or by a number of positions determined by manipulating the randomizer) and/or may be required to skip his/her next turn. In some embodiments, the player is required to move his/her game piece backwards along the playing path to an activity position (e.g., the activity position immediately preceding the activity position to which the game piece was advanced).

While the present invention has been particularly shown and described with reference to embodiments thereof, it will be understood by those of ordinary skill in the art that various changes in form and details may be made therein without departing from the spirit and scope of the present invention as defined by the following claims.

1. A game, comprising:
a playing surface comprising a playing path that includes a plurality of healthy food positions, a plurality of energy-draining food positions and a plurality of activity positions;
a plurality of game pieces that are operable to advance along the playing path; and
a randomizer configured to determine how many positions a player can advance one of the plurality of games pieces along the playing path.

2. (canceled)

3. The game of claim 1, wherein one or more of the plurality of healthy food positions comprises a visual representation of a fruit, a vegetable, an animal protein and/or a nut/seed.

4-5. (canceled)

6. The game of claim 1, wherein one or more of the plurality of energy-draining food positions comprises a visual representation of a cereal grain, a dairy product, a legume, a starchy tuber, a refined sugar and/or a refined vegetable oil.

7-8. (canceled)

9. The game of claim 1, wherein one or more of the plurality of activity positions comprises a graphical representation of one or more persons exercising.

10-13. (canceled)

14. The game of claim 1, further comprising instructions whereby a player whose game piece is situated on one of the activity positions is directed to perform an exercise.

15-21. (canceled)

22. The game of claim 1, further comprising instructions for rewarding the player if he/she performs the exercise as instructed.

23-24. (canceled)

25. The game of claim 1, further comprising instructions for penalizing the player if he/she fails to perform the exercise as instructed.

26-27. (canceled)

28. The game of claim 1, further comprising a plurality of puzzle piece sets.

29. (canceled)

30. The game of claim 28, wherein each of the puzzle piece sets comprises one or more puzzle pieces representing fruits, one or more puzzle pieces representing vegetables, one or more puzzle pieces representing animal proteins and one or more puzzle pieces representing nuts/seeds.

31. (canceled)

32. The game of claim 28, wherein each of the plurality of puzzle piece sets comprises instructions for rewarding a player who collects each puzzle piece in the puzzle piece set.

33-37. (canceled)

38. A game comprising:
a playing surface comprising images depicting a plurality of contiguous positions that define a playing path, the plurality of contiguous positions comprising;
a plurality of healthy food positions, wherein each of the healthy food positions comprises a graphical representation of a food type selected from the group consisting of fruits, vegetables, animal proteins and nuts/seeds,
a plurality of energy-draining food positions, wherein each of the energy-draining food positions comprises a graphical representation of a food type selected from the group consisting of cereal grains, dairy products, legumes, starchy tubers, refined sugars and refined oils, and
a plurality of activity positions;
a plurality of game pieces that are operable to advance along the playing path, wherein each game piece comprises a figurine of a person exercising;
a randomizer configured to determine how many positions a player can advance one of the plurality of games pieces along the playing path;
a plurality of activity cards, wherein each of the plurality of activity cards comprises graphical and/or textual information communicating instructions for performing an exercise for a specified duration, within a specified period of time and/or for a specified number of repetitions; and
a plurality of puzzle piece sets, wherein each of the puzzle piece sets comprises one or more puzzle pieces representing fruits, one or more puzzle pieces representing vegetables, one or more puzzle pieces representing animal proteins and one or more puzzle pieces representing nuts/seeds.

39. (canceled)

40. The game of claim 38, wherein each of the plurality of activity cards further comprises instructions for rewarding a player who performs the exercise as instructed and/or instructions for penalizing a player who fails to perform the exercise as instructed.

41. The game of claim 38, wherein each of the plurality of puzzle piece sets comprises at least one puzzle piece that represents fruits, at least one puzzle piece that represents vegetables, at least one puzzle piece that represents animal proteins and at least one puzzle piece that represents nuts/seeds.

42. (canceled)

43. The game of claim 1, wherein the game is a board game comprising a physical playing surface.

44. The game of claim 1, wherein the game is an electronic game comprising a computer program product on a tangible computer readable storage medium.

45-76. (canceled)
